(19) United States
(12) Patent Application Publication
(10) Pub. No.: US 2009/0019401 A1
(43) Pub. Date: Jan. 15, 2009

(54) METHOD TO PROVIDE A GRAPHICAL USER INTERFACE (GUI) TO OFFER A THREE-DIMENSIONAL (3D) CYLINDERICAL MENU AND MULTIMEDIA APPARATUS USING THE SAME

(75) Inventors: Wan-je PARK, Seoul (KR); Sang-gon SONG, Yeongcheon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/028,050

(22) Filed: Feb. 8, 2008

(30) Foreign Application Priority Data
Jul. 9, 2007 (KR) 2007-68883

(51) Int. Cl. G06F 3/048

(52) U.S. Cl. 715/841

(57) ABSTRACT

A method to provide a graphical user interface (GUI) to offer a 3D cylindrical menu, and a multimedia apparatus using the same. The method to provide a GUI includes generating a 3D cylindrical menu displaying a menu on its surface, and rotating the 3D cylindrical menu according to a manipulation of an input device by a user to enable the user to select an item of the menu.

### CROSS-REFERENCE TO RELATED APPLICATIONS

This application claims priority under 35 U.S.C. §119 from Korean Patent Application No. 10-2007-0068883, filed on Jul. 9, 2007, in the Korean Intellectual Property Office, the disclosure of which is incorporated herein by reference in its entirety.

### BACKGROUND OF THE INVENTION

1. Field of the Invention

The present general inventive concept relates to a graphical user interface (GUI), and a multimedia apparatus, and more particularly, to providing a GUI to offer a three-dimensional menu, and a multimedia apparatus using the same.

2. Description of the Related Art

A graphical user interface (GUI) method to select an icon or menu using a pointer has been universally used. A user moves a cursor to an item at a desired location using an input device such as a mouse or touch pad to input a user's command in a GUI environment, and can execute the function corresponding to the item by pressing a key on the input device.

If a user uses an input device such as a mouse or touch pad, the user must move a cursor to a desired location and press a key, which is inconvenient.

If the user uses a touch screen, the user can select a desired menu or icon without moving the cursor, but must scroll up or down along a scroll bar to drag the menu.

As multimedia apparatuses are becoming miniaturized, a method to effectively display a menu on a small size screen is required. A method to indicate a menu which is easy for a user to know how to use is also necessary.

Because a user of a GUI prefers a more convenient and intuitive way of using menu, a method is required which enables a user to select a menu with convenience and ease of operation.

### SUMMARY OF THE INVENTION

The present general inventive concept provides a method to provide a GUI to offer a 3D cylindrical menu with which a user can select a menu more intuitively, and a multimedia apparatus using the same.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a method to provide a graphical user interface (GUI) including generating a three dimensional (3D) cylindrical menu having at least one menu item displayed on a surface of the 3D cylindrical menu, and rotating the 3D cylindrical menu according to a manipulation of an input device by a user to enable the user to select at least one menu item displayed on the 3D cylindrical menu.

The input device may be a touch screen.

The rotating the 3D cylindrical menu may adjust a rotational speed of the 3D cylindrical menu according to the manipulation of the user using the input device.

If the manipulation speed of the input device is fast, the rotating the 3D cylindrical menu may include controlling a rotational speed of the 3D cylindrical menu so that the 3D cylindrical menu rotates rapidly, and if the manipulation speed of the input device is slow, the rotating the 3D cylindrical menu may include controlling a rotational speed of the 3D cylindrical menu so that the 3D cylindrical menu rotates slowly.

The method may further include generating separate 3D cylindrical submenus displaying submenu items associated with the selected menu item on its surface, if one of the menu items is selected.

The method may further include displaying the 3D cylindrical submenus separately at one side of the 3D cylindrical menu.

The method may further include displaying the 3D cylindrical submenus in an overlapping manner at one side of the 3D cylindrical menu.

The method may further include displaying an icon at one or more sides of the 3D cylindrical menu to represent that associated submenus exist.

The method may further include generating a plurality of 3D cylindrical menus indicating a series of numbers thereon, receiving numbers selected by the user as the user rotates the 3D cylindrical menus and selects numbers therefrom, and setting a security function to allow the user to use a multimedia apparatus only if the numbers selected by the user correspond to a password.

The method may further include controlling a volume of an audio output according to a rotation of the 3D cylindrical menu.

The method may further include adjusting a radio frequency selection according to a rotation of the 3D cylindrical menu.

The method may further include generating a first cylindrical menu displaying an initial sound/character of the Korean alphabet, generating a second cylindrical menu displaying a middle sound/character of the Korean alphabet, generating a third cylindrical menu displaying a final sound/character of the Korean alphabet, and combining the sounds/characters displayed on the first through third cylindrical menus selected according to the manipulation by the user of the input device and displaying a syllable/word composed of the selected sounds/characters.

The method may further include searching stored files using the composed syllable/word.

The method may further include generating a plurality of 3D cylindrical menus displaying letters of the English alphabet, and combining letters of the English alphabet from the plurality of 3D cylindrical menus selected according to the manipulation of the user using the input device, and displaying an English word or a portion of an English word composed of the selected letters of the English alphabet.

The method may further include searching stored files using the composed English word or the portion of the composed English word.

The foregoing and/or other aspects and utilities of the present general inventive concept may also be achieved by providing a multimedia apparatus, including an input device controlled by a user, and a controller to control a display to generate a three dimensional (3D) cylindrical menu displaying at least one menu item on a surface of the 3D cylindrical menu, and to rotate the 3D cylindrical menu according to manipulation of the input device by the user to enable the user to select at least one menu item.

The input device may be a touch screen.

The controller may adjust to control a rotational speed of the 3D cylindrical menu according to the manipulation by the user of the input device.

The foregoing and/or other aspects and utilities of the present general inventive concept may also be achieved by providing a method to provide a graphical user interface (GUI), including generating a three dimensional (3D) cylindrical menu displaying at least one menu item on a surface of the 3D cylindrical menu, and rotating the at least one menu item according to a manipulation of an input device by a user to enable the user to select at least one menu item.

The foregoing and/or other aspects and utilities of the present general inventive concept may also be achieved by providing a method to provide a graphical user interface (GUI), including displaying an item to be selected from a plurality of items of a menu at a center portion of the menu, and displaying a remainder of the items in an upper or lower portion of the menu based on the selected item, receiving a manipulation command through a touch screen to scroll the menu in an upward or downward direction, and scrolling the menus in the upward or downward direction according to the received manipulation command.

The method may further include creating a first menu area and a second menu area which are separate from each other, and displaying the menu in the first menu area and an associated submenu in the second menu area.

The foregoing and/or other aspects and utilities of the present general inventive concept may also be achieved by providing a method to provide a graphical user interface (GUI), including displaying an item to be selected at a center portion of a menu, and detecting a touch by a user on a touch screen, where scrolling the menu in an upward or a downward direction, if the touch is along an upward or a downward direction is detected on the touch screen.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a block diagram of a multimedia apparatus according to the present general inventive concept;

FIG. 2 is a flowchart illustrating a method to provide a GUI to offer a cylindrical menu according to an exemplary embodiment of the present general inventive concept;

FIGS. 3A through 3C are views illustrating a method to display cylindrical submenus according to an exemplary embodiment of the present general inventive concept;

FIGS. 4A through 4F are views illustrating a method to display cylindrical submenus according to another exemplary embodiment of the present general inventive concept;

FIGS. 5A through 5C are views illustrating a method to display cylindrical submenus according to a further exemplary embodiment of the present general inventive concept;

FIG. 6 is a view illustrating a method to set a password using a cylindrical menu according to yet another exemplary embodiment of the present general inventive concept.

FIG. 7 is a view illustrating a method to control a volume using a cylindrical menu according to yet another exemplary embodiment of the present general inventive concept;

FIG. 8 is a view illustrating a method to control a radio channel using a cylindrical menu according to yet another exemplary embodiment of the present general inventive concept;

FIG. 9 is a view illustrating a method to search a Korean title file using a cylindrical menu according to yet anther exemplary embodiment of the present general inventive concept;

FIG. 10 is a view illustrating a method to search an English title file using a cylindrical menu according to yet anther exemplary embodiment of the present general inventive concept; and

FIGS. 11A through 11C are views illustrating a method to apply a cylindrical menu to a flexible display apparatus according to yet another exemplary embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

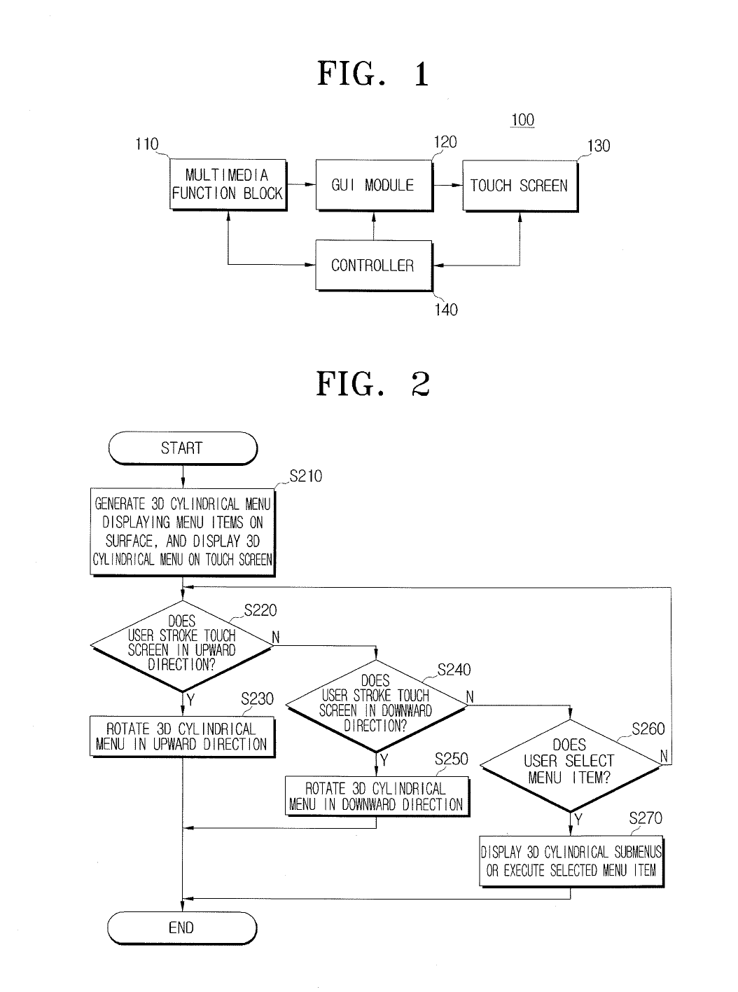

FIG. 1 is a block diagram of a multimedia apparatus 100 applicable to the present general inventive concept. Referring to FIG. 1, a multimedia apparatus 100 may include a multimedia function block 110, a graphical user interface (GUI) module 120, a touch screen 130, and a controller 140.

The multimedia function block 110 performs basic functions of multimedia apparatus 100 such as file search, game mode, recording, music playback, movie playback, photo playback, document writing, and digital multimedia broadcast (DMB) playback.

The GUI module 120 combines a GUI employing a three dimensional (3D) cylindrical menu having an image generated from the multimedia function block 110 included on a surface of the 3D cylindrical menu.

The touch screen 130 displays an image combining a GUI which is embodied using the 3D cylindrical menu output from the GUI module 120. The touch screen 130 receives a user's short touch, a long touch, or a drag manipulation using a user's finger.

The controller 140 controls the operation of the multimedia function block 110 according to a user's manipulation of a display manipulation device such as the touch screen 130, or according to a user's manipulation of a non-display manipulation device (not illustrated) such as a mouse, a touch pad, or a wheel. When such a non-display manipulation device is used, a separate display is also used to display the GUI and the 3D cylindrical menu.

The controller 140 controls the GUI module 120 to display the GUI corresponding to the user's manipulation of the touch screen 130, as described above.

If a user inputs a command to scroll a 3D cylindrical menu, using the touch screen 130, the controller 140 controls the GUI module 120 to rotate and display the 3D cylindrical menu according to the input command.

For example, if the user strokes the 3D cylindrical menu along an upward direction using the touch screen 130, the controller 140 controls the GUI module 120 so that the 3D cylindrical menu is rotated in the upward direction and displayed on the touch screen 130. On the other hand, if the user strokes the 3D cylindrical menu along a downward direction using the touch screen 130, the controller 140 controls the GUI module 120 so that the 3D cylindrical menu is rotated in the downward direction and displayed on the touch screen 130.

The controller 140 adjusts a rotational speed of the 3D cylindrical menu according to the manipulation of the touch screen 130 to control the rotation of the 3D cylindrical menu. For example, if a user strokes the 3D cylindrical menu using the touch screen 130 at a high speed, the controller 140 controls the GUI module 120 to rotate the 3D cylindrical menu at a high speed. On the other hand, if a user strokes the 3D cylindrical menu using the touch screen 130 at a low speed, the controller 140 controls the GUI module 120 to rotate the 3D cylindrical menu at a low speed.

If a user inputs a command to select one item from the 3D cylindrical menu using the touch screen 130, the controller 140 controls the GUI module 120 to display one or more submenus associated with the item selected according to the input command.

In particular, if a user inputs a command to select one of the items from the 3D cylindrical menu using the touch screen 130, the controller 140 generates on or more 3D cylindrical submenu, each having submenu items according to the input command. The controller 140 may control the GUI 130 to display the 3D cylindrical submenus separately at one side of the 3D cylindrical menu, or the controller 140 may control the GUI 130 to display the 3D cylindrical submenus in an overlapping manner at one side of the 3D cylindrical menu.

The touch screen 130 may be included in a flexible display apparatus (not illustrated), which has a bendable display panel to enable the display to form a cylindrical shape.

The controller 140 may control the GUI 130 to display an icon representing that there are the submenus at one or both sides of the 3D cylindrical menu. If a user clicks on the icon with a mouse or a touch pad button, or drags the icon using the touch screen 130, the controller 140 may control the GUI 130 to overlap the 3D cylindrical submenus on one or more sides of the icon.

The controller 140 may generate a plurality of rotating 3D cylindrical menus having a series of numbers. The controller 140 receives a number selected by the user using the touch screen 130 from among the numbers displayed by the rotating 3D cylindrical menus.

The controller 140 may set a security function so that a user is allowed to use the multimedia apparatus 100 only if a number selected for input by the user corresponds to a preset password.

The controller 140 may control a volume setting of an audio output of the multimedia apparatus 100 according to a rotation of the 3D cylindrical menu. For example, if the 3D cylindrical menu is rotated in an upward direction, the controller 140 may control the audio output to increase in volume, and on the other hand, if the 3D cylindrical menu is rotated in a downward direction, the controller 140 may control the audio output to decrease in volume.

The controller 140 may adjust a tuner of a receiver (not illustrated) of the multimedia apparatus 100 to select a radio frequency according to a rotation of the 3D cylindrical menu. For example, if the 3D cylindrical menu is rotated in an upward direction, the radio frequency being selected increases in frequency, and on the other hand, if the 3D cylindrical menu is rotated in a downward direction, the radio frequency being selected decreases in frequency.

The controller 140 may search among stored multimedia files. For example, the controller 140 may generate a first cylindrical menu displaying an initial sound, or character, of the Korean alphabet, a second cylindrical menu displaying a middle sound, or character, of the Korean alphabet, and a third cylindrical menu displaying a final sound, or character, of the Korean alphabet. In the Korean language, one syllable is formed by combining the initial, middle, and final sounds, or characters. Accordingly, the controller 140 may control a storage medium (not illustrated) to search a multimedia file for a file title that begins with a combined syllable, since the syllable is composed by the sounds, or characters, selected according to a user manipulation of the touch screen 130.

The controller 140 may generate a first cylindrical menu, a second cylindrical menu, and a third cylindrical menu displaying letters of the English alphabet. The controller 140 may combine, for example, three letters selected according to a manipulation of the touch screen 130 by the user. The controller 140 may control the storage medium (not illustrated) to search for a multimedia file having a title that begins with the combined three letters selected by the user, or in another embodiment to search for a title of a file having the combined three selected letters at any location in the title.

The controller 140 may control the operation of the multimedia function block 110 to execute a command to play multimedia content stored in a storage medium (not illustrated) when such a command is selected by a user.

The process of using a cylindrical menu will be explained in detail with reference to FIG. 2, which is a flowchart illustrating a method to provide a GUI, which is a cylindrical menu according to an exemplary embodiment of the present general inventive concept.

Referring to FIG. 2, in operation S210, the controller 140 controls the GUI module 120 to generate a 3D cylindrical menu displaying menu items on a surface of the 3D cylindrical menu, and to display the 3D cylindrical menu on a display, such as the touchscreen 130.

In operation S220, the controller 140 determines whether a user strokes the touch screen 130 in an upward direction, and if so, in operation S230 the controller 140 controls the GUI module 120 to rotate the 3D cylindrical menu in an upward direction.

If in operation S220 the controller 140 determines that a user does not stroke the touch screen 130 in an upward direction, then in operation S240 the controller 140 determines whether the user strokes the touch screen 130 in a downward direction. If it is determined in operation S240 that the touch screen has been stroked in a downward direction, then in operation S250 the controller 140 controls the GUI module 120 to rotate the 3D cylindrical menu in a downward direction.

If it is determined in operation S240 that the touch screen has not been stroked in a downward direction, then in operation S260 the controller 140 determines whether a user has selected a menu item by touching the touch screen 130 to select an item of the menu. If not, then the controller returns to operation S220. If the user has selected a menu item, then in operation S270 the controller 140 controls the GUI module 120 to generate and display one or more 3D cylindrical submenus associated with the selected item, or controls the multimedia function block 110 to execute a multimedia item selected from the menu. For example, if a user selects the item “Music,” the controller 130 controls the GUI module 120 to generate a 3D cylindrical submenu having submenu items such as “Album,” “Track”, and “Artist,” which are related to and associated with the item “Music.” If a user selects a music file such as “Holy Night.mp3,” the controller 130 controls the multimedia function block 110 to play back the selected music file.

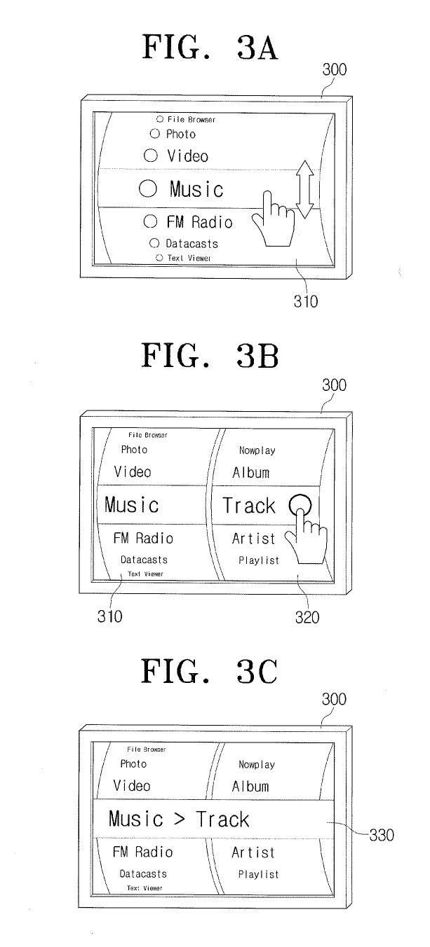

Various exemplary embodiments using a 3D cylindrical menu will be explained in detail with reference to FIGS. 3A through 11C which are views illustrating a method to display cylindrical submenus according to an exemplary embodiment of the present general inventive concept.

Referring to FIG. 3A, a three dimensional (3D) cylindrical menu 310 representing menus on a surface of the 3D cylindrical menu 310 is displayed on a display 300. In an exemplary embodiment, the display 300 offers a touch screen function. A user can rotate the 3D cylindrical menu 310 by stroking the 3D cylindrical menu 310 on the display 300 using a finger in upward and downward directions. If a user touches the display 300 at a location where a desired item is positioned in the 3D cylindrical menu 310, the touched item is selected.

If a user rapidly strokes the 3D cylindrical menu 310 on the display 300, the 3D cylindrical menu 310 is rotated rapidly in the stroke direction, and if a user slowly strokes the 3D cylindrical menu 310, the 3D cylindrical menu 310 is rotated slowly in the stroke direction.

Referring to FIG. 3B, in response to a user touching on an item on the 3D cylindrical menu 310, a 3D cylindrical submenu indicating associated submenu items appear on a surface of the submenu, which are generated and displayed separately (that is, in a non-overlapping format). In an example illustrated in FIG. 3B, a user selects the menu item “Music” from the 3D cylindrical menu 310 by touching the display 300, and a 3D cylindrical submenu 320 having submenu items associated with the selected item “Music” are displayed separately at one side of the 3D cylindrical menu 310. The user may stroke the display 300 displaying the 3D cylindrical submenu along upward and downward directions, and select a desired submenu item from the 3D cylindrical submenus.

The selected item from a 3D cylindrical submenu is displayed prominently in the center of the 3D cylindrical menu 310, as illustrated. The item may be provided in a bold type font, or a block type font to emphasize the selected item, or large font, or capital font, or other font so that a user can recognize the item which has been selected.

The title of the menu that is currently activated may also be indicated and highlighted. In another embodiment, for example, as the 3D cylindrical submenu 320 having associated submenu items are activated and displayed as illustrated in FIG. 3B, the 3D cylindrical submenu is displayed more brightly or boldly than the 3D cylindrical menu 310. Accordingly, a user can easily recognize that the 3D cylindrical submenu 320 is activated. Alternatively, the activated 3D cylindrical menu 310 may be represented in enlarged or bold or other highlighting fonts.

In these embodiments, the user can select items while viewing concurrently the parent menu and its associated submenu.

FIG. 3C is a view illustrating when a user selects a submenu item of the 3D cylindrical submenu 320. That is, the user selects the menu item “Music” from the 3D cylindrical menu 310 and the submenu item “Track” from the 3D cylindrical submenu 320.

When the user touches the display 300 to select the submenu item “Track” from the 3D cylindrical submenu 320, a caption 330 of the selected menu and submenu item may be displayed on the display 300. For example, as the caption 330 “Music>Track” is displayed on the display 300 in FIG. 3C, the user can recognize that the menu and submenu items “Music” and “Track” have been selected.

The method to display the 3D cylindrical submenu 320 separately has been described in detail with reference to FIGS. 3A through 3C.

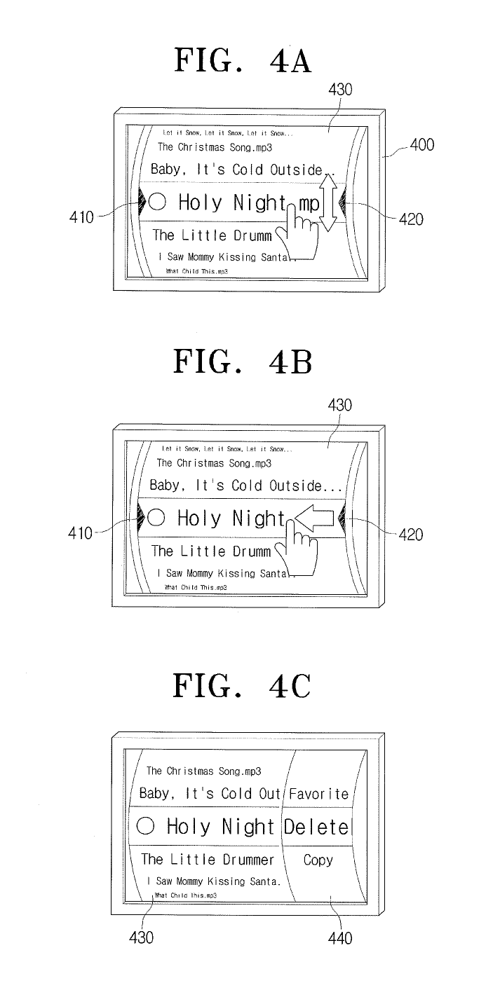

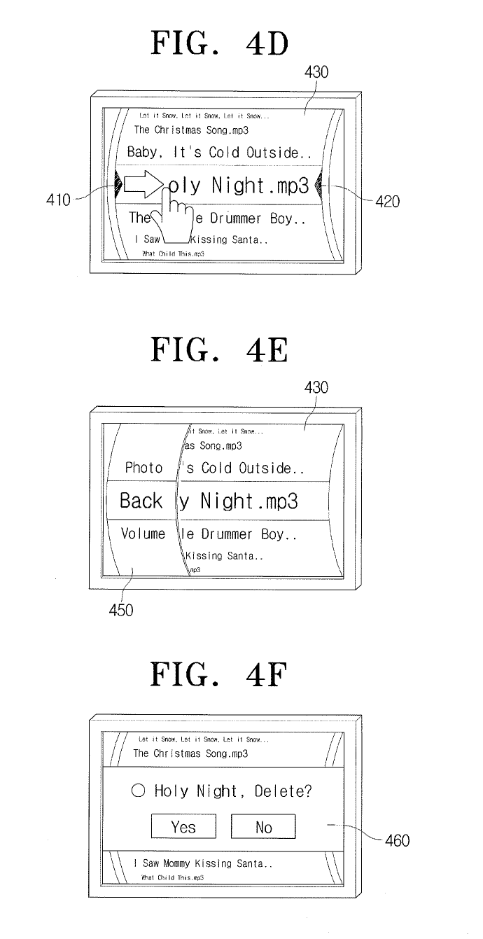

Hereinbelow, a method to display right 3D cylindrical submenus 440 in an overlapping manner will be explained in detail with reference to FIGS. 4A through 4F. FIGS. 4A through 4F are views illustrating a method to display cylindrical submenus according to another exemplary embodiment of the present general inventive concept.

FIG. 4A is a view illustrating a display 400 displaying left and right icons 410 and 420 to indicate that there are submenus available to be formed at right and left sides of a 3D cylindrical menu 430. Referring to FIG. 4A, the 3D cylindrical menu 430 includes a listing of stored multimedia files which may be a music file, a video file, or another type of multimedia file.

Referring to FIG. 4C, a music file may include an associated first group of submenu items including “Favorite,” “Delete,” and “Copy,” and referring to FIG. 4E, a second group of submenu items including “Photo,” “Back,” and “Volume.” The 3D cylindrical menu 430 is used to select the music file and the left and right icons 410 and 420 are selected to select the respective submenu from among these two groups of submenu items associated with the selected music file.

As illustrated in FIG. 4A, black triangles are provided at both sides of the 3D cylindrical menu 430 which are the left and right icons 410 and 420. If the left and right icons 410 and 420 are selected, submenus corresponding to the left and right icons 410 and 420 may be displayed on either side of the 3D cylindrical menu 430.

FIGS. 4B and 4C are views illustrating a method to select the right icon 420. If a user touches the right icon 420 and strokes the menu along a leftward direction, the controller 140 displays the right side 3D cylindrical submenu 440, including the first group of submenu items at the right side of the 3D cylindrical menu 430. The right side 3D cylindrical submenu 440 may be displayed in an overlapping form with respect to the 3D cylindrical menu 430.

FIGS. 4D and 4E are views illustrating a method to select the left icon 410. If a user touches the left icon 410 and strokes the menu along a rightward direction, the controller 140 displays a left side 3D cylindrical submenu 450, including the second group of submenu items at the left side of the 3D cylindrical menu 430. The left side 3D cylindrical submenu 450 may be displayed in an overlapping form with respect to the 3D cylindrical menu 430.

FIG. 4F is a view illustrating a process of performing a function corresponding to an item selected from the 3D cylindrical submenus 440 and 450. Referring to FIG. 4C, if a user selects the “Delete” submenu item from the right side 3D cylindrical submenu 440, a dialogue box 460 is displayed on the display 300 to ask whether a user intends to delete the music file. The 3D cylindrical menu 430 may remain displayed in its original form behind the dialogue box 460.

As the right side 3D cylindrical submenu 440 is displayed in the above manner, it may seem to the user as though the user is pulling out the menus at will. Accordingly, the user can intuitively and easily use the right side 3D cylindrical submenu 440.

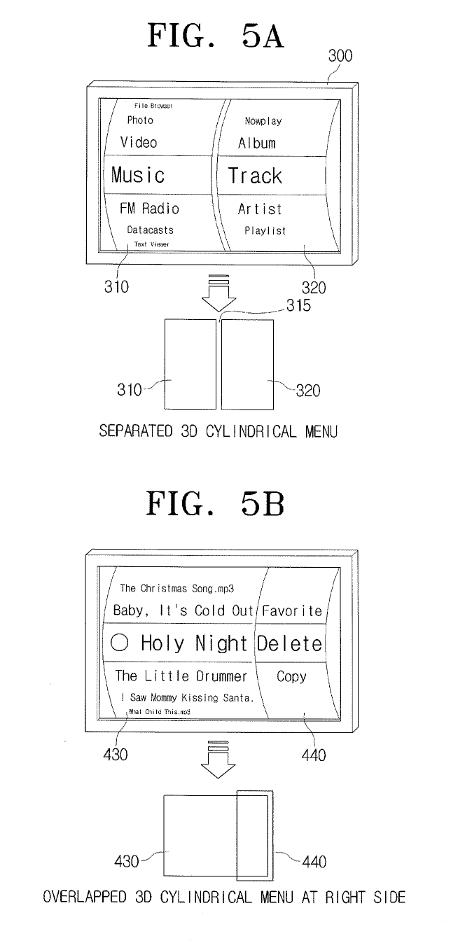

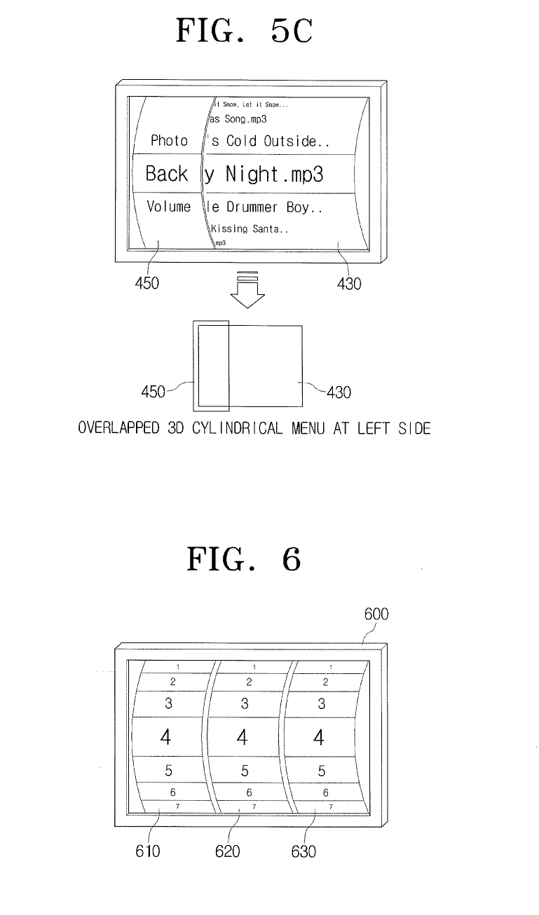

FIGS. 5A through 5C are views illustrating a method to display cylindrical submenus according to an exemplary embodiment of the present general inventive concept.

FIG. 5A illustrates an embodiment where the 3D cylindrical menu 310 and the 3D cylindrical submenu 320 are displayed separately from the 3D cylindrical menu 310. Referring to FIG. 5A, the 3D cylindrical menu 310 is formed apart from the 3D cylindrical submenu 320 where a predetermined gap 315 is disposed between the 3D cylindrical menu 310 and the 3D cylindrical submenu 320. The width of the gap 315 may be set by the user.

FIG. 5B illustrates the right side 3D cylindrical submenu 440 in an overlapped position at the right side of the 3D cylindrical menu 430. FIG. 5C illustrates left side 3D cylindrical submenu 450 in an overlapped position at the left side of the 3D cylindrical menu 430. The right side and left side 3D cylindrical submenus 440and 450 are overlapped on the 3D cylindrical menu 430 while the 3D cylindrical menu 430 remains in its original position as illustrated in FIGS. 5B and 5C.

The method to separate the 3D cylindrical menus of FIG. 5A is generally used to indicate a broad classification narrowing into a sub-classification. The method of positioning the 3D cylindrical menu at the right side as illustrated in FIG. 5B is generally used to select functions for a multimedia file. The method of positioning the 3D cylindrical menu at the left side as illustrated in FIG. 5C is generally used to select an item of a submenu to return to other parent menus. However, other alternative ways may be appropriately adopted.

FIG. 6 is a view illustrating a method to set a password using a cylindrical menu according to yet another exemplary embodiment of the present general inventive concept. Referring to FIG. 6, the method to set a password is embodied using three 3D cylindrical menus 610, 620, and 630.

Numbers 0 to 9 are represented on the respective 3D cylindrical menus 610, 620, and 630. A user can rotate the respective 3D cylindrical menu 610, 620, 630 by stroking a display 600, which may be the touch screen 130. As doing so, the user can input a selected 3-digit number. In other embodiments, any quantity of numbers may be selected. The controller 140 can set a security function to allow the use of the multimedia apparatus 100 only when a number input by a user corresponds to a preset password.

For example, if a password is set to “486”, when a user turns on the multimedia apparatus 100, the three 3D cylindrical menus 610, 620, and 630 are displayed on the display, and a message prompting that a password be entered is displayed. The user can select the numbers “4”, “8”, and “6” from the three 3D cylindrical menus 610, 620, and 630 using the touch screen 130, and thereby be allowed to use the multimedia device 100 since the password matches the number input. If the user inputs an incorrect password more than a predetermined number of times (for example five times), the multimedia apparatus 100 may be disabled.

While three 3D cylindrical menus are used in the exemplary embodiment of the present general inventive concept, it is merely an exemplary embodiment of the present general inventive concept. In addition, while the 3D cylindrical menu displaying numbers 0 through 9 are used in the exemplary embodiment of the present general inventive concept for convenience of description, the range of the numbers displayed may be varied.

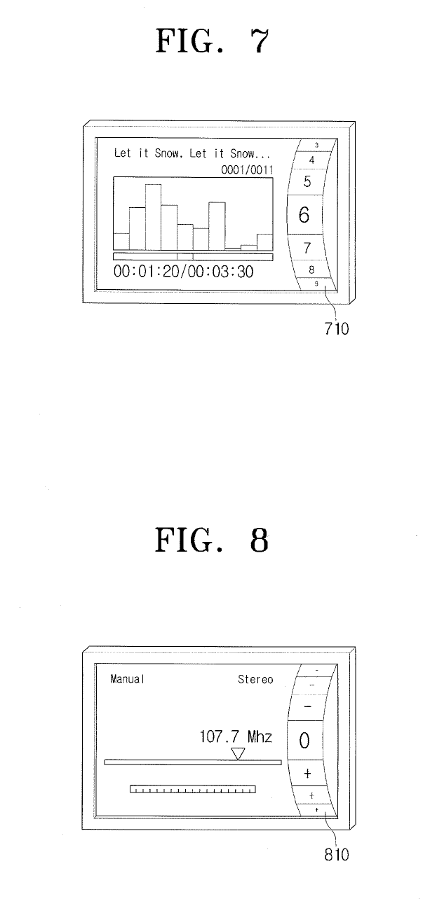

FIG. 7 is a view illustrating a method to control a volume setting of an audio output using a cylindrical menu according to yet another exemplary embodiment of the present general inventive concept. Referring to FIG. 7, the method to control a volume is embodied using one 3D cylindrical menu 710.

The 3D cylindrical menu 710 to control a volume setting displays a series of numbers thereon. For example, if the numbers 1 through 10 are displayed on the 3D cylindrical menu 710, a user can adjust the volume setting in 10 stages. The more numbers that are displayed in the 3D cylindrical menu 710, the more finely the user can adjust the volume setting to control a corresponding audio output volume. As a user scrolls the menu in an upward or downward direction, higher numbers are displayed which correspond to a higher volume setting and lower numbers are displayed which correspond to a lower volume setting.

FIG. 8 is a view illustrating a method to control a selection of a radio channel using a cylindrical menu according to yet another exemplary embodiment of the present general inventive concept. Referring to FIG. 8, the method to control the selection of a radio channel is embodied using one 3D cylindrical menu 810.

The 3D cylindrical menu 810 to control a radio channel displays icons “+”, and “−” thereon. A user adjusts the 3D cylindrical menu 810 in upward and downward directions to increase or decrease the radio channel frequency. While the 3D cylindrical menu 810 is used to adjust the radio channel frequency, the radio channel frequency may be controlled in another manner. For example, a series of numbers may be displayed on the 3D cylindrical menu 810, each being associated with an assigned radio channel.

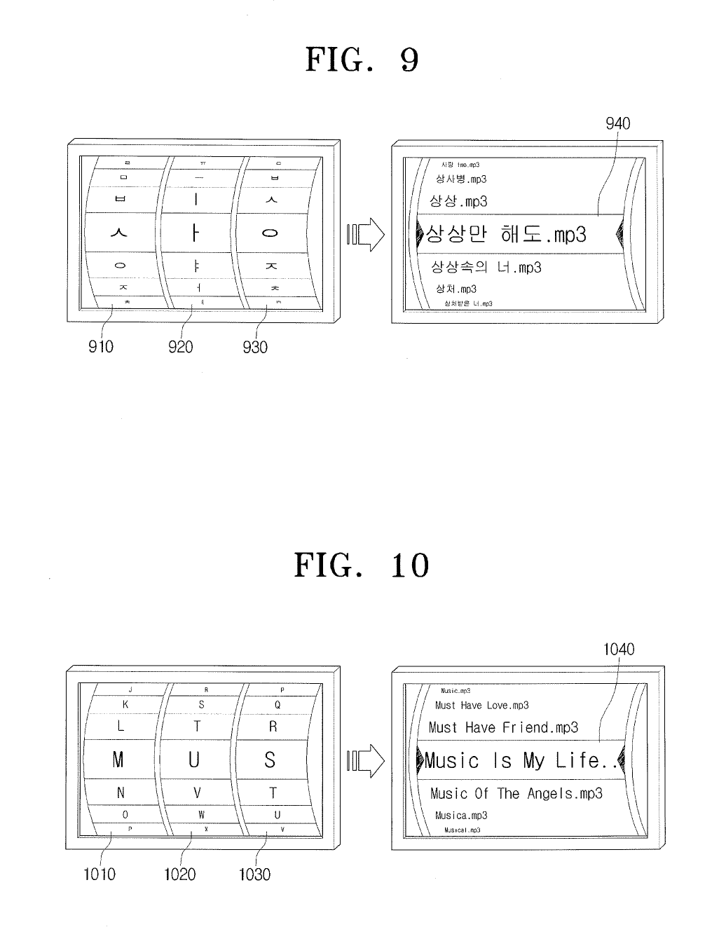

FIG. 9 is a view illustrating a method to search Korean title files using a cylindrical menu according to yet anther exemplary embodiment of the present general inventive concept. Referring to FIG. 9, the file search according to the exemplary embodiment of the present general inventive concept may be embodied using three 3D cylindrical menus 910, 920, and 930.

The first 3D cylindrical menu 910, displaying an initial sound/character of the Korean alphabet, the second 3D cylindrical menu 920 displaying a middle sound/character of the Korean alphabet, and the third 3D cylindrical menu 930 displaying a final sound/character of the Korean alphabet, are provided in this exemplary embodiment of the present general inventive concept. The controller 140 forms one syllable by combining sounds/characters displayed on the first, second, and third 3D cylindrical menus 910, 920, and 930. The controller 140 searches stored files for a file title beginning with the combined syllable from the stored files.

For example, if a user selects the Korean sound/character “ [symbol] ” from the first 3D cylindrical menu 910, the Korean sound/character “ [symbol] ” from the second 3D cylindrical menu 920, and, the Korean sound/character “ [symbol] ” from the third 3D cylindrical menu 930, as illustrated in FIG. 9, a combined word/syllable may be selected, such as “ [symbol] ” As a result, a file 940 with the title of [symbol] can be searched from among the stored files.

The files are searched in a manner of comparing one syllable or word composed of the initial, middle, final sounds/characters with the first syllable or word of the stored file, but other manners are possible. For example, the controller 140 may search the files beginning with an initial sound/character selected from just one 3D cylindrical menu that displays initial sounds/characters.

Alternatively, six 3D cylindrical menus may be used to search files for a title beginning with the two syllables/words that match the user-selected syllables/words, the six 3D cylindrical menus supply two 3-sound/character syllables/words.

FIG. 10 is a view illustrating a method to search for an English title for a file using a cylindrical menu according to yet anther exemplary embodiment of the present general inventive concept. Referring to FIG. 10, the method to search for an English title of a file may include three 3D cylindrical menus 1010, 1020, and 1030.

The first 3D cylindrical menu 1010, the second 3D cylindrical menu 1020, and the third 3D cylindrical menu 1030, each displaying letters of the English alphabet thereon are provided in the exemplary embodiment of the present general inventive concept. The controller 140 forms all or part of an English word by combining letters on the first, second, and third 3D cylindrical menus 1010, 1020, and 1030. The controller 140 searches files for a title of a file beginning with the whole English word, or with the first three letters of the English word, from among stored files.

For example, if a user selects the letter “M” from the first 3D cylindrical menu 1010, “U” from the second 3D cylindrical menu 1020, and “S” from the third 3D cylindrical menu 1030, making up a part of an English word beginning with the letters “MUS”, a file titled “Music is my life .mp3”, which begins with the letters “MUS”, can be searched for from among the stored files.

While three letters of the English alphabet are compared with the titles of the stored files in the above example, files may be searched in other manners, as well. For example, one, two or more than four 3D cylindrical menus may be used to search for files that begin with, or match somewhere in a title a combination of, the selected letters.

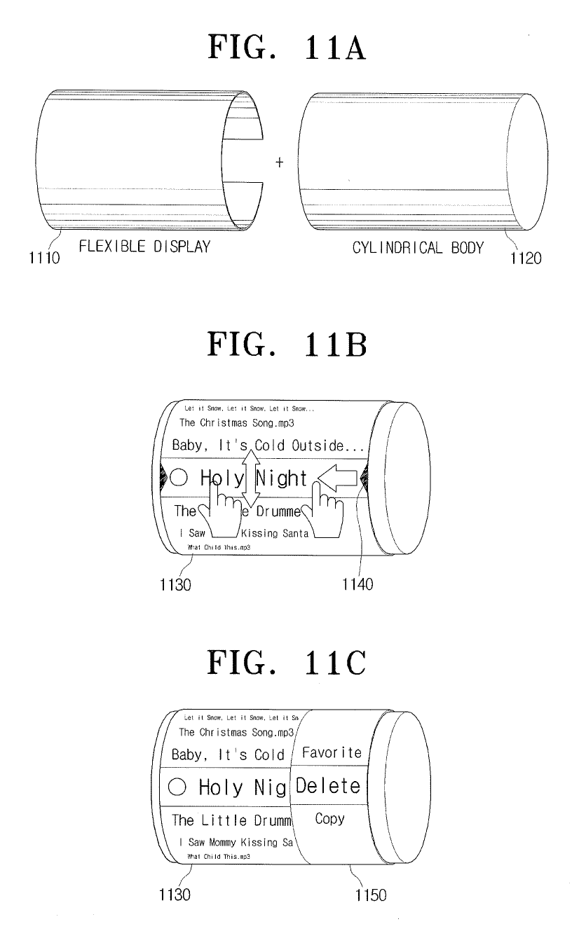

FIGS. 11A through 11C are views illustrating a method to apply a cylindrical menu to a flexible display apparatus according to yet anther exemplary embodiment of the present general inventive concept. Referring to FIG. 11A, the flexible display apparatus may include a flexible display 1110 and a cylindrical body 1120.

The flexible display 1110 is bendable as illustrated in FIG. 11A to surround the entire surface of the cylindrical body 1120. As a result, a user using the flexible display 1110 feels as if he is physically rotating a cylinder as he makes his selections on a 3D cylindrical display, and this provides a feeling of ease of use and intuitiveness to a user.

A 3D cylindrical menu may be displayed on a 3D cylindrical display apparatus as illustrated in FIG. 11B. A user can stroke the flexible display 1110 in upward and downward directions, and rotate the 3D cylindrical menu 1130 as illustrated in FIGS. 4A and 4B. The user can stroke a submenu icon 1140 along a leftward direction, and select submenu items of associated submenus.

Referring to FIG. 11B, if a hand of the user strokes the submenu icon 1140 at the right side, 3D cylindrical submenus 1150 are displayed. The user may feel as if he physically draws in the 3D cylindrical submenus 1150.

Various exemplary embodiments of the present general inventive concept are described with reference to FIGS. 3A through 11C, but these are merely exemplary embodiments of the present general inventive concept. For example, a 3D cylindrical menu may have various shapes, such as an elliptic cylinder and polygon pillar. A polygon pillar having surfaces corresponding to the menus may be used for a 3D menu. The menu may also be embodied using a 3D figure instead of the pillar.

A touch screen is provided as an input device in the exemplary embodiment of the present general inventive concept, but it is merely an exemplary embodiment of the present general inventive concept for convenience of description. Alternatively, the input device may be another input device such as a mouse wheel, touch pad, and scroll bar.

The exemplary embodiment of the present inventive concept may be applicable to various multimedia apparatuses. The multimedia apparatus 100 may be a television (TV), digital versatile disc player (DVDP), hard disc drive (HDD) player, Blue Ray disc (BD) player, video cassette recorder (VCR), home theater, personal multimedia player (PMP), MPEG layer 3 (MP3) player, digital camera, or a digital camcorder.

As described above, a method to provide a GUI to offer a 3D cylindrical menu, and a multimedia apparatus using the same according to the present general inventive concept are provided, to enable a user to select a menu in a convenient and intuitive way.

Furthermore, an analog type menu is applied to a digital display apparatus to provide digital scalability and analog manipulation convenience. Therefore, the user can search menus more intuitively.

Furthermore, the cylindrical menus are overlapped to enable the user to view the menus at a glance. As a result, the user can easily recognize a relation between a parent menu and associated submenus.

The present general inventive concept can also be embodied as computer-readable codes on a computer-readable medium. The computer-readable medium can include a computer-readable recording medium and a computer-readable transmission medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although a few embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. A method to provide a graphical user interface (GUI), comprising:
generating a three dimensional (3D) cylindrical menu having at least one menu item displayed on a surface of the 3D cylindrical menu; and
rotating the 3D cylindrical menu according to a manipulation of an input device by a user to enable the user to select at least one menu item displayed on the 3D cylindrical menu.

2. The method of claim 1, wherein the input device is a touch screen.

3. The method of claim 1, wherein the rotating the 3D cylindrical menu adjusts a rotational speed of the 3D cylindrical menu according to the manipulation of the user using the input device.

4. The method of claim 1, wherein:
if the manipulation speed of the input device is fast, the rotating the 3D cylindrical menu comprises controlling a rotational speed of the 3D cylindrical menu so that the 3D cylindrical menu rotates rapidly; and
if the manipulation speed of the input device is slow, the rotating the 3D cylindrical menu comprises controlling a rotational speed of the 3D cylindrical menu so that the 3D cylindrical menu rotates slowly.

5. The method of claim 1, wherein if one of the menu items is selected, generating a separate 3D cylindrical submenu displaying submenu items associated with the selected menu item on a surface of the 3D cylindrical submenu.

6. The method of claim 5, further comprising:
displaying the 3D cylindrical submenu separately at one side of the 3D cylindrical menu.

7. The method of claim 5, further comprising:
displaying the 3D cylindrical submenu in an overlapping manner at one side of the 3D cylindrical menu.

8. The method of claim 1, further comprising:
displaying an icon at one or more sides of the 3D cylindrical menu to represent that associated submenus exist.

9. The method of claim 1, further comprising:
generating a plurality of displayed 3D cylindrical menus each indicating a series of numbers thereon;
receiving numbers selected by the user as the user rotates the displayed 3D cylindrical menus and selects a plurality of numbers therefrom; and
setting a security function to allow the user to use a multimedia apparatus only if the numbers selected by the user correspond to a password.

10. The method of claim 1, further comprising:
controlling a volume of an audio output according to a rotation of the 3D cylindrical menu.

11. The method of claim 1, further comprising:
adjusting a radio frequency selection according to a rotation of the 3D cylindrical menu.

12. The method of claim 1, further comprising:
generating a first 3D cylindrical menu displaying an initial sound/character of the Korean alphabet;
generating a second 3D cylindrical menu displaying a middle sound/character of the Korean alphabet;
generating a third 3D cylindrical menu displaying a final sound/character of the Korean alphabet; and
combining the sounds/characters displayed on the first through third 3D cylindrical menus selected according to the manipulation by the user of the input device and displaying a syllable/word composed of the selected sounds/characters.

13. The method of claim 12, further comprising:
searching stored files using the composed syllable/word.

14. The method of claim 1, further comprising:
generating a plurality of 3D cylindrical menus displaying letters of the English alphabet; and
combining letters of the English alphabet selected from the plurality of 3D cylindrical menus selected according to the manipulation of the user using the input device, and displaying an English word or a portion of an English word composed of the selected letters of the English alphabet.

15. The method of claim 14, further comprising:
searching stored files using the composed English word or the portion of the composed English word.

16. A multimedia apparatus, comprising:
an input device controlled by a user; and
a controller to control a display to generate a three dimensional (3D) cylindrical menu displaying at least one menu item on a surface of the 3D cylindrical menu, and to rotate the 3D cylindrical menu according to a manipulation of the input device by the user to enable the user to select at least one menu item.

17. The apparatus of claim 16, wherein the input device is a touch screen.

18. The apparatus of claim 16, wherein the controller adjusts to control a rotational speed of the 3D cylindrical menu according to the manipulation by the user of the input device.

19. A method to provide a graphical user interface (GUI), comprising:
generating a three dimensional (3D) cylindrical menu displaying at least one menu item on a surface of the 3D cylindrical menu; and
rotating the at least one menu item according to a manipulation of an input device by a user to enable the user to select at least one menu item.

20. A method to provide a graphical user interface (GUI), comprising:
displaying an item to be selected from a plurality of items of a menu at a center portion of the menu, and displaying a remainder of the items in an upper or lower portion of the menu based on the selected item;
receiving a manipulation command through a touch screen to scroll the menu in an upward or downward direction; and
scrolling the menu in the upward or downward direction according to the received manipulation command.

21. The method of claim 20, wherein
if one item is selected from the plurality of items of the menu, creating a first menu area and a second menu area which are separate from each other; and
displaying the menu in the first menu area and an associated submenu in the second menu area.

22. A method to provide graphical user interface (GUI), comprising:
displaying an item to be selected at a center portion of a menu; and
detecting a touch by a user on a touch screen; wherein
if the touch is along an upward or a downward direction is detected on the touch screen, scrolling the menu in the corresponding upward or downward direction.
